(19) United States
(12) Patent Application Publication
(10) Pub. No.: US 2026/0280478 A1
(43) Pub. Date: Sep. 17, 2026

(54) SOLAR RAIL RAPID INSTALL DESIGN

(71) Applicant: Nextpower LLC, Fremont, CA (US)

(72) Inventor: Craig Bradley Edward Wildman, Kensington, CA (US)

(21) Appl. No.: 19/542,873

(22) Filed: Feb. 18, 2026

Related U.S. Application Data
(60) Provisional application No. 63/770,806, filed on Mar. 12, 2025.

(51) Int. Cl. H02S 30/10; H02S 20/10; H02S 20/32

(52) U.S. Cl. CPC H02S 30/10; H02S 20/10; H02S 20/32

(57) ABSTRACT

Methods and systems are described herein for coupling a plurality of solar module frames to a torque tube via a rail. The rail includes a plurality of rotatable clamps configured to rotate from a first, open position to a second, closed position. When the plurality of rotatable clamps are in the second position, the plurality of rotatable clamps are placed over each of the solar module frames thereby securing the plurality of solar module frames to the rail, and thereby the torque tube.

### RELATED APPLICATIONS

This application claims the benefit of U.S. Provisional Patent Application No. 63/770,806, filed Mar. 12, 2025, the entire contents of which are incorporated herein by reference.

### TECHNICAL FIELD

This disclosure relates generally to solar tracker systems, and more particularly to systems and methods of providing frames for solar modules within solar tracker systems designed for simplified install.

### BACKGROUND

Solar cells and solar panels are most efficient in sunny conditions when oriented towards the sun at a certain angle. Many solar panel systems are designed in combination with solar trackers, which follow the sun's trajectory across the sky from east to west to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds of individual solar modules that are mechanically coupled to support structures.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application. The present disclosure seeks to address the shortcomings of prior tracker systems.

### SUMMARY

In general, the present disclosure relates generally to solar tracker systems, and more particularly to systems and methods of providing frames for solar modules within solar tracker systems designed for simplified install. In one example a method for coupling a first solar module frame and a second solar module frame to a torque tube may include placing a rail at the torque tube, the rail having a plurality of rotatable clamps. The method may further include placing the first solar module frame at a first side of the rail, placing the second solar module frame at a second side of the rail, and rotating the plurality of rotatable clamps from a first, open position to a second, closed position. When the plurality of rotatable clamps are in the second position, the plurality of rotatable clamps may be placed over a portion of the first solar module frame and a portion of the second solar module frame, thereby securing the first solar module frame and the second solar module frame to the rail.

Additionally or alternatively, each of the plurality of rotatable clamps may be secured to the rail via a threaded fastener, the threaded fastener comprising one of a bobtail fastener, a screw, or a bolt.

Additionally or alternatively, each of threaded fasteners for each of the plurality of rotatable clamps may be preinstalled into the rail prior to placing the rail at the torque tube.

Additionally or alternatively, the method may further include tightening each of the threaded fasteners to cause the plurality of rotatable clamps to engage the first solar module frame or the second solar module frame when the plurality of rotatable clamps are placed over the first solar module frame and the second solar module frame respectively, the tightening of the threaded fasteners securing the first solar module frame and the second solar module frame to the rail.

Additionally or alternatively, the plurality of rotatable clamps and the rail may define a frame distance therebetween when the plurality of rotatable clamps are in the second, closed position.

Additionally or alternatively, the frame distance may define a frame distance width, and wherein the frame distance width is greater than a thickness of the first solar module frame and the second solar module frame.

Additionally or alternatively, the rail may include a plurality of locating tabs, the first solar module frame and the second solar module frame may each include a plurality of holes and placing the first solar module frame and the second solar module frame at the rail may include alignment of each hole of the plurality of holes with a corresponding locating tab of the plurality of locating tabs of the rail.

Additionally or alternatively, rotating of the plurality of rotatable clamps may include rotating the plurality of rotatable clamps approximately 90-degrees from the first, open position to the second, closed position.

Additionally or alternatively, the rail may define a first opening at a first end of the rail and a second opening at a second end of the rail.

In another example, a rail for coupling a solar module to a torque tube may include a rail base having a first end, a second end opposite the first end, a first side, and a second side opposite the second side, the rail base configured to couple to the torque tube, a plurality of locating tabs positioned on the rail base, and a plurality of rotatable clamps, the plurality of rotatable clamps rotatable from a first, open position to a second, closed position, the plurality of rotatable clamps configured to engage a flanged region of the solar module and secure the solar module to the rail.

Additionally or alternatively, the rail may further define a first opening at the first end of the rail base and defines a second opening at the second end of the rail base.

Additionally or alternatively, the first opening and the second opening may enable relative movement between the first side and the second side of the rail base.

Additionally or alternatively, the first opening may enable the first side to move laterally closer to, or laterally further away from, the second side than a width of rail base.

Additionally or alternatively, the plurality of rotatable clamps may be configured to be pre-installed on the rail base.

Additionally or alternatively, the rail may include a plurality of backing tabs, each of the plurality of backing tabs corresponding with one of the plurality of rotatable clamps, each of the plurality of backing tabs configured to support the corresponding rotatable clamp when the rotatable clamp is in the closed position to aid in exerting a downward force on a coupling flange of the solar module.

Additionally or alternatively, each of the plurality of backing tabs may have a height approximately the same as a thickness of the coupling flange of the solar module.

Additionally or alternatively, each of the plurality of locating tabs may be configured to align with a corresponding one of a plurality of holes on a coupling flange of the solar module, the plurality of locating tabs configured to protrude through the plurality of holes of the solar module when the solar module is aligned with the rail.

In another example, a method for coupling a first solar module frame to a torque tube may include placing a first rail and a second rail at the torque tube, the first rail including a first plurality of rotatable clamps and the second rail including a second plurality of rotatable clamps, placing a first side of the first solar module frame at the first rail, placing a second side of the first solar module frame at the second rail, rotating the first plurality of rotatable clamps from a first, open position to a second, closed position, the first plurality of rotatable clamps coupling the first side of the first solar module frame to the first rail, and rotating the second plurality of rotatable clamps from a first, open position to a second, closed position, the second plurality of rotatable clamps coupling the second side of the first solar module frame to the second rail.

Additionally or alternatively, the first plurality of rotatable clamps may contact a first coupling flange located on the first side of the first solar module frame, and the second plurality of rotatable clamps may contact a second coupling flange located on the second side of the first solar module frame.

Additionally or alternatively, the first plurality of rotatable clamps may be coupled to the first rail via a corresponding plurality of first fasteners, the plurality of first fasteners being preinstalled to the first rail, and the second plurality of rotatable clamps may be coupled to the second rail via a corresponding plurality of second fasteners, the plurality of second fasteners being preinstalled to the second rail. The method may further include securing the first plurality of rotatable clamps to the first rail via the plurality of first fasteners when the first plurality of rotatable clamps are in the closed position, and securing the second plurality of rotatable clamps to the second rail via the plurality of second fasteners when the second plurality of rotatable clamps are in the closed position.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of a solar tracker;

FIG. 2 is a schematic, top view of a solar tracking system;

FIG. 3A is a schematic, perspective view of a solar tracker in accordance with the disclosure;

FIG. 3B is a schematic, perspective view of the solar tracker, as in FIG. 3A, with solar modules removed;

FIG. 4 is a schematic, perspective view of a portion of a torque tube including a rail in accordance with the disclosure;

FIG. 5A is a schematic, perspective view of a portion of a solar tracker including a solar module and a rail in accordance with the disclosure, with solar module glass removed;

FIG. 5B is a schematic, perspective view of a portion of a solar module frame coupled to a rail and a torque tube with a plurality of clamps in an open position;

FIG. 5C a schematic, top-perspective view of the portion of the solar module frame coupled to the rail and the torque tube, as in FIG. 5B, with the plurality of clamps in a closed position;

FIG. 6 is an enlarged view of one of the plurality of clamps shown in Circle 6 in FIG. 5C;

FIG. 7 is a bottom view of a solar module including the solar module frame that can be used with the plurality of rotatable clamps, as in FIGS. 5A to 5C;

FIG. 8A is a side, cross-sectional view of a solar module including the solar module frame that can be used with the plurality of rotatable clamps, as in FIGS. 5A to 5C;

FIG. 8B is a side, cross-sectional view of the solar module frame that can be used with the plurality of rotatable clamps, as in FIG. 8A, shown without the solar module;

FIG. 9 is a flow diagram illustrating a method for coupling a first solar module frame and a second solar module frame to a torque tube; and

FIG. 10 is a flow diagram illustrating a method for coupling a first solar module frame to a torque tube.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar module frames configured to facilitate improved structural stability for solar modules in solar tracking systems. Certain embodiments disclosed herein can improve solar tracking system structural stability while increasing the efficiency of solar module frame installation and reducing costs (e.g., frame and/or support material costs) associated with solar module frames and supports.

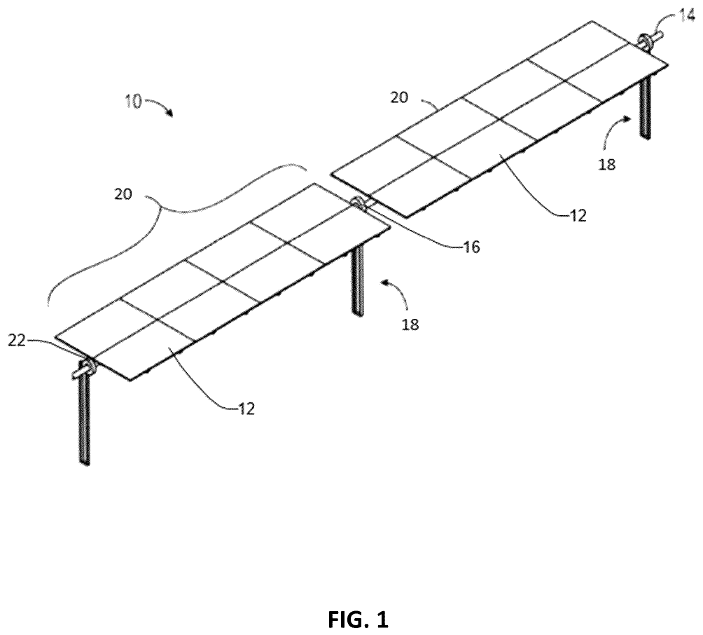

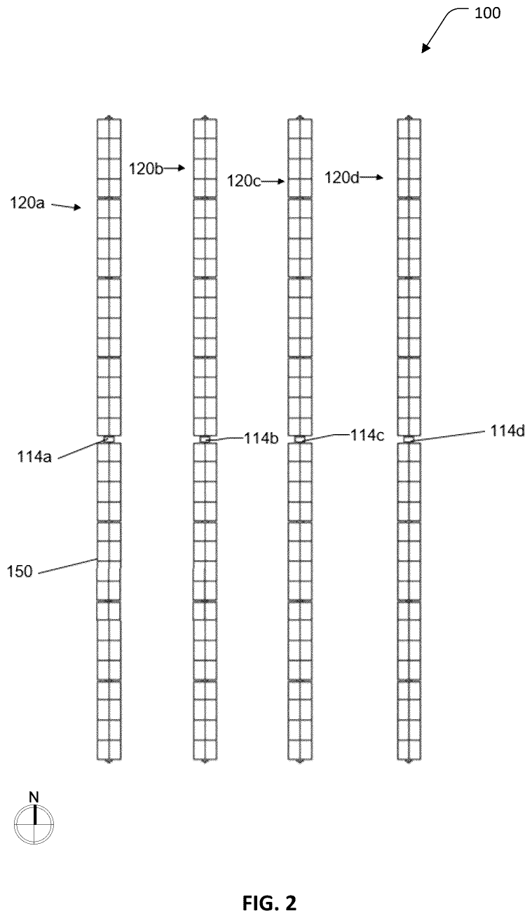

Referring now to the drawings, FIG. 1 illustrates a perspective view of a common arrangement of a solar tracker 10 provided in accordance with the present disclosure. The solar tracker 10 has bays 20 defined by the distance between ground piers 18 (generally referenced herein as piers 18). The solar tracker 10 may be a part of a larger solar tracker system that may include a plurality of solar trackers 10 arranged in rows, an example of which is shown in FIG. 2\, where each row of solar trackers 10 may be referred to as a solar tracker row. FIG. 1 illustrates two bays 20 of the solar tracker 10. However, it will be appreciated that the solar tracker 10 may include four bays, six bays, ten bays, twenty bays, or any other suitable number of bays as desired. At each pier 18 is either a bearing 22 or, as shown in FIG. 1, a drive mechanism 16 shown, for example, near the center of the solar tracker 10. Each of the bearings 22 and the drive mechanism 16 are supported by one of the piers 18. Activation of the drive mechanism 16 rotates a torque tube 14 about an axis of rotation and thus rotates one or more solar modules 12 mounted to the torque tube 14 such that the solar modules 12 can be oriented to a desired position. That desired position may be a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piers 18 is reduced or substantially eliminated and to absorb torsional loads applied to the torque tube 14 by wind loading. In addition, since there may be just a single drive mechanism 16, the specifications for the torque tube 14 must also seek to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

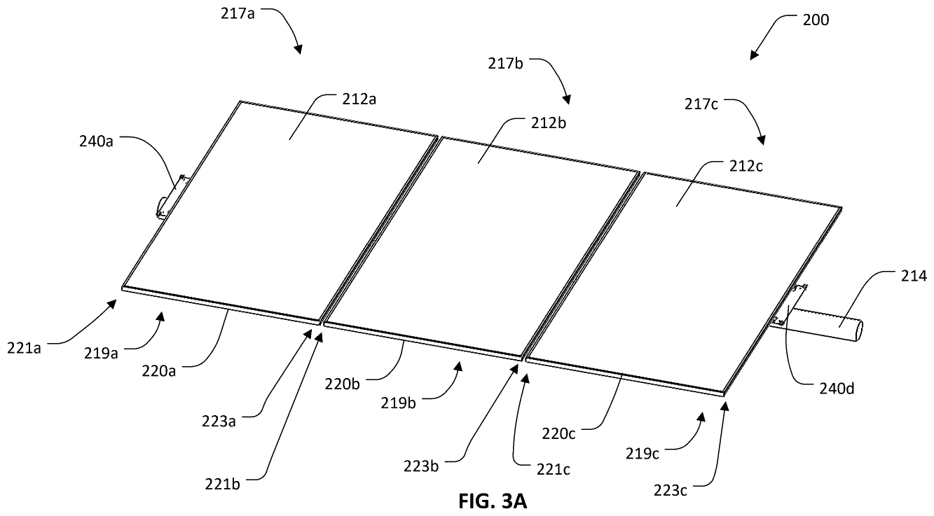

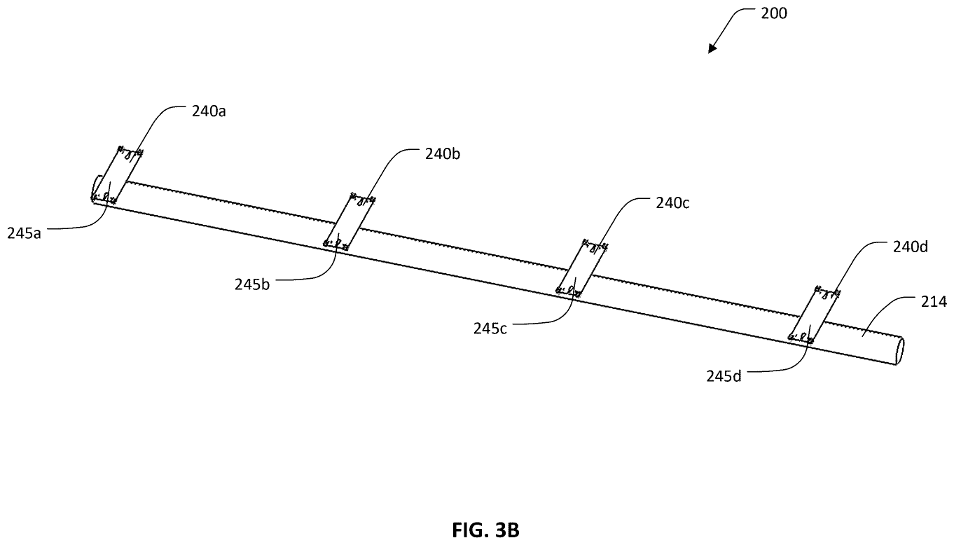

FIG. 3A is a schematic, perspective view of a solar tracker 200 in accordance with the disclosure, and FIG. 3B is a schematic, perspective view of the solar tracker 200 with solar modules 212 removed. The solar tracker 200 may be an example of the solar tracker 10, as in FIG. 1. The solar tracker 200 may include a plurality of solar modules including a first solar module 212a, a second solar module 212b, and a third solar module 212c, generally referred to herein as plurality of solar modules 212. While it is shown that there are three solar modules, it may be contemplated that there may be six solar modules, eight solar modules, twenty solar modules, fifty solar modules, one hundred solar modules, or any other suitable number of solar modules, as desired. The first solar module 212a, the second solar module 212b, and the third solar module 212c may each include a solar module frame 220a, 220b, 220c, respectively. The solar module frames 220a, 220b, 220c may generally be referred to herein as a plurality of solar module frames 220. Each of the solar module frames 220a, 220b, 220c may include a first side 221a, 221b, 221c, respectively, and a second side 223a, 223b, 223c, respectively. Each of the plurality of solar modules 212 may be coupled to a torque tube 214 via a plurality of rails 240, described further with reference to FIG. 3B. Each one of the plurality of solar modules 212 may include a first end 217 (217a, 217b, 217c) and a second end 219 (219a, 219b, 219c). It will be appreciated that the description of the solar tracker 10 with reference to FIG. 1, further applies to the solar tracker 200.

FIG. 3B depicts the torque tube 214 having the plurality of rails 240 coupled thereto. The plurality of rails 240 may include a first rail 240a, a second rail 240b, a third rail 240c, and a fourth rail 240d, generally referred to herein as the plurality of rails 240. While it is shown that there are four rails, it may be contemplated that there may be two rails, six rails, eight rails, twenty rails, fifty rails, or any other suitable number of rails, as desired. The first rail 240a, the second rail 240b, the third rail 240c, and the fourth rail 240d may each include a rail base 245a, 245b, 245c, 245d, respectively, generally referred to herein as rail base 245. The rail base 245 may be configured to support one or more solar module frames 220 (e.g., a pair of solar module frames).

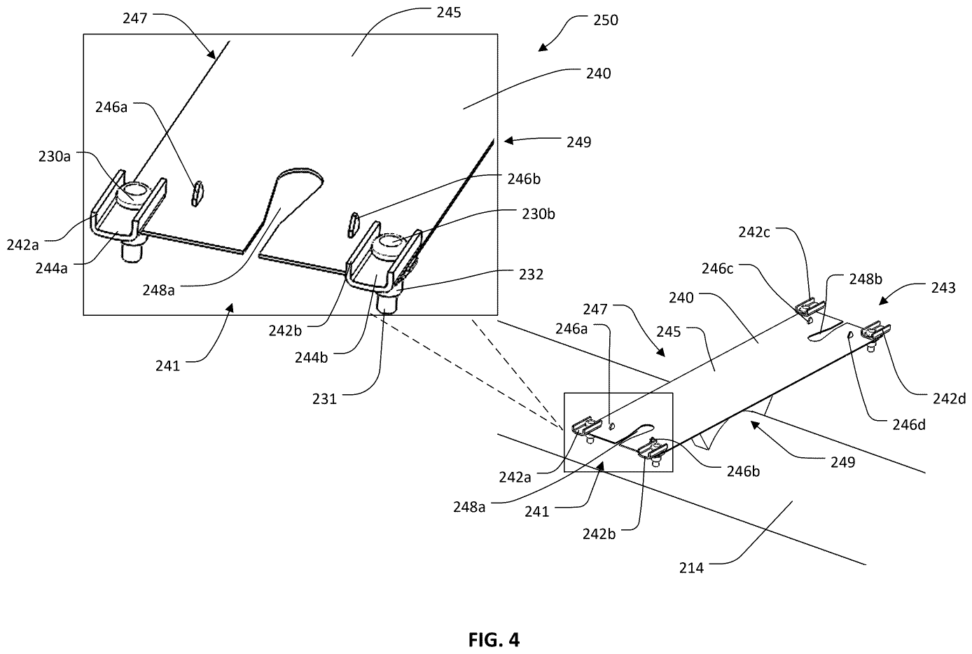

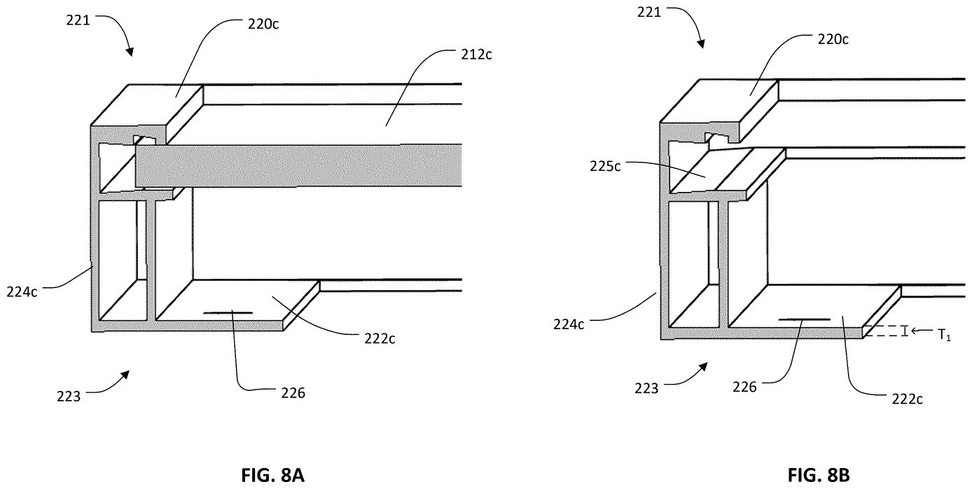

FIG. 4 is a schematic, perspective view of a portion of the torque tube 214 including the rail 240. The rail 240 may include the rail base 245 which may include a first end 241, a second end 243 opposite the first end 241, a first side 247, and a second side 249 opposite the first side 247. As shown in FIG. 4, the rail base 245 may include one or more tabs/pins that project out of the rail base 245. For example, the rail base 245 may include a plurality of locating tabs 246. The plurality of locating tabs 246 may include a first locating tab 246a, a second locating tab 246b, a third locating tab 246c, and a fourth locating tab 246d. While it is shown that there are four locating tabs 246, it may be contemplated that there may be one locating tab, two locating tabs, six locating tabs, eight locating tabs, twelve locating tabs, or any other suitable number of locating tabs, as desired. In some examples, it may be contemplated that there may not be any locating tabs used (e.g., zero locating tabs). In other examples, there may be one locating tab per solar module and/or one locating tab per rail. The plurality of locating tabs 246 may be positioned adjacent the first end 241 of the rail 240 and/or the second end 243 of the rail 240. In some examples, the plurality of locating tabs 246 may be positioned at any suitable location on the rail 240. In some examples, the plurality of locating tabs 246 may be configured as locating features to align with holes in the solar module frame, the holes shown further with reference to FIG. 8. In some examples, when one of the plurality of solar module frames 220 is placed on the rail 240, an installer may know it is centered when each of the plurality of locating tabs 246 protrude into the holes in the solar module frame 220, thereby potentially eliminating the need for alignment in the direction transverse to the torque tube 214.

The rail base 245 of the rail 240 may further include a first opening 248a cut out at the first end 241 of the rail base 245 and a second opening 248b cut out at the second end 243 of the rail base 245. The first opening 248a and the second opening 248b each may serve to alleviate stressors on a plane of the rail base 245. In some examples, the first opening 248a and the second opening 248b may enable movement between the first side 247 and the second side 249 of the rail base 245 (e.g., the rail 240), such as, for example, the first side 247 may move laterally closer to, or laterally further away from, the second side 249 within a width of the rail base 245. For example, in use, the plurality of solar modules 212 rotate with the torque tube 214 as the torque tube 214 rotates to follow the sun's trajectory across the sky (e.g., east to west). The plurality of solar modules 212 may be rotated to extreme angles of a permitted range (e.g., +/−75 degrees or more). Further, the torque tube 214 may undulate as the underlying ground changes. In such cases, when the plurality of solar modules 212 rotate at higher angles, and with the undulation of the torque tube 214, each solar module 212 of the plurality of solar modules 212 may extend away from an adjacent solar module 212 the end closer to the underlying ground (e.g., the first end 217 or the second end 219 of the solar module 212) and may compress toward an adjacent solar module 212 at the opposite end (e.g., the first end 217 or the second end 219 that is furthest from the underlying ground). Thus, the first opening 248a and the second opening 248b allow for flexing of the rail 240 as each of the plurality of solar modules 212 extend away and/or compress toward each adjacent solar module 212, thereby reducing the load that may be transferred to the rail 240 and/or the plurality of rotatable clamps 242.

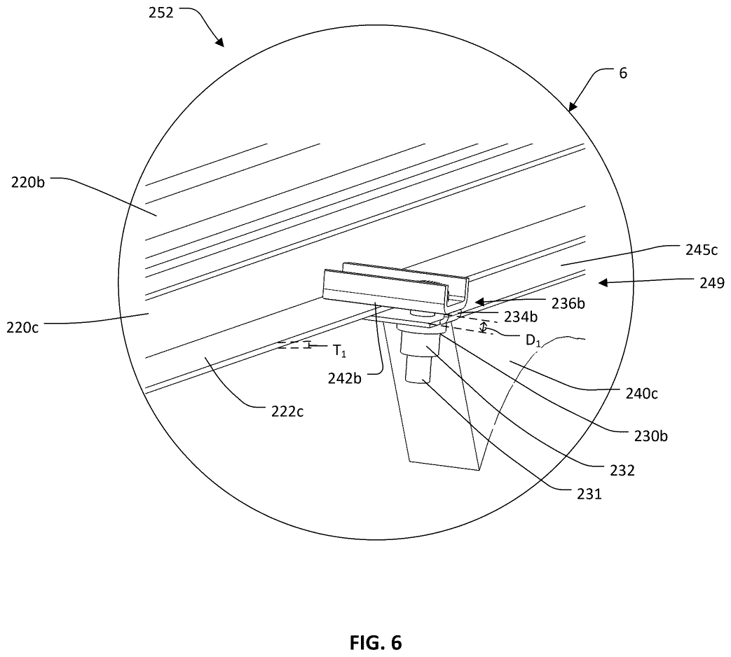

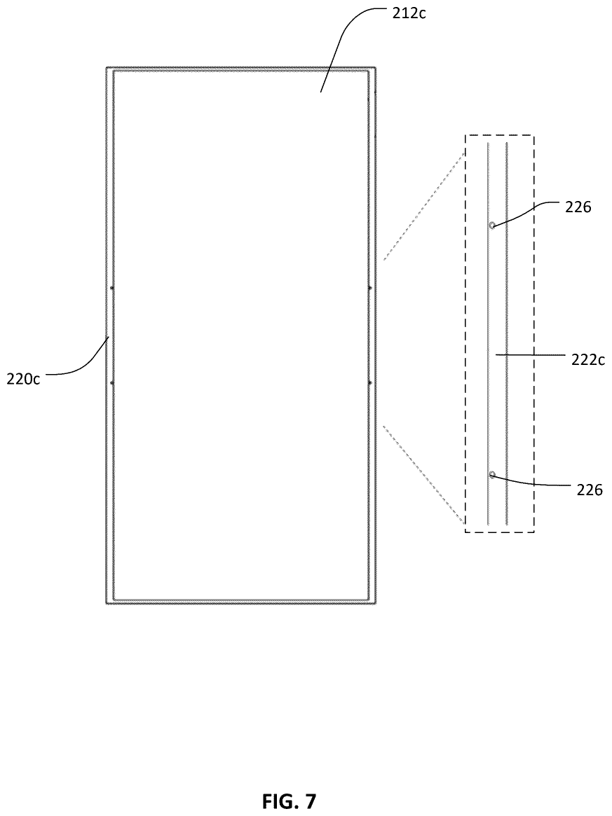

As shown in FIG. 4, the rail 240 may include a plurality of rotatable clamps 242. The plurality of rotatable clamps 242 may include a first rotatable clamp 242a, a second rotatable clamp 242b, a third rotatable clamp 242c, and a fourth rotatable clamp 242d, generally referred to herein as plurality of rotatable clamps 242. The plurality of rotatable clamps 242 may be rotatable from a first, open position 250, as shown in FIG. 4, to a second, closed position 252, as shown in FIGS. 6B and 7. As illustrated in FIG. 4, the plurality of rotatable clamps 242 can be secured by a plurality of threaded fastening mechanisms 230 (e.g., a first fastening mechanism 230a, a second fastening mechanism 230b, a third fastening mechanism 230c, and a fourth fastening mechanism 230d), such as nuts and bolts, by bobtail fastener, by screws, or by other means. If a nut & bolt, screw, or a bobtail fastener are used, the bolt, screw, or bobtail fastener pin can be loosely pre-installed into the rail 240.

As discussed, the plurality of fastening mechanisms 230 may be pre-installed into the rail 240 prior to placing the rail 240 at the torque tube 214. In some cases, the plurality of rotatable clamps 242 may further be pre-installed onto the rail with the plurality of fastening mechanisms 230. In some examples, each of the plurality of fastening mechanisms 230 may include a first portion 231 configured to extend through each of the respective rotatable clamps 242 and the rail 240. Once through the rail 240, a second portion 232 may be loosely coupled to the first portion 231 on an underside of the rail 240, as shown in further detail with reference to FIG. 7. For example, when a bobtail fastener is used, a bobtail pin may be press-fit into each of the plurality of rotatable clamps 242 such that each of the plurality of rotatable clamps 242 may be rotationally coupled to each respective bobtail pin (e.g., fastening mechanism 230). A bobtail collar may be loosely coupled on the bobtail pin on an underside of the rail 240. The bobtail collar may not be swaged, but rather may have a tab that sticks into threading on the bobtail pin shaft so that the bobtail collar does not fall off. In other examples, a bolt may be inserted into each of the plurality of rotatable clamps 242 such that each of the plurality of rotatable clamps 242 may be rotationally coupled to the bolt (e.g., fastening mechanism 230). A nut may be loosely coupled to the bolt on an underside of the rail 240 such that the nut does not fall off the bolt. These are just examples.

The plurality of rotatable clamps 242 may be configured to secure a solar module (e.g., solar modules 212) on one side or on both sides of itself to the rail 240. The plurality of rotatable clamps 242 may each include a tab portion 244 (244a, 244b, 244c, 244d) that may be configured to land on a flanged region (e.g., coupling flange 222c shown in FIGS. 7 and 8) of the solar module frame 220, and when each one of the plurality of clamps 242 is secured to the rail 240, apply a preload downward on the solar module frame 220 toward the rail 240 and thereby secure the solar module frame 220 to the rail 240 which is secured to the torque tube 214. In some examples, the rotating of the plurality of rotatable clamps 242 may include rotating the plurality of rotatable clamps 242 approximately 90-degrees from the first, open position 250 to the second, closed position 252, as shown in further detail with reference to FIGS. 6A and 6B. In some examples, the rotating of the plurality of rotatable clamps may include rotating the plurality of rotatable clamps greater than 90 degrees from a first, open position to a second, closed position. In such examples, the plurality of rotatable clamps may be specially configured (e.g., having a small end portion) to enable the plurality of rotatable clamps to rotate greater than 90 degrees from the first, open position to the second, closed position

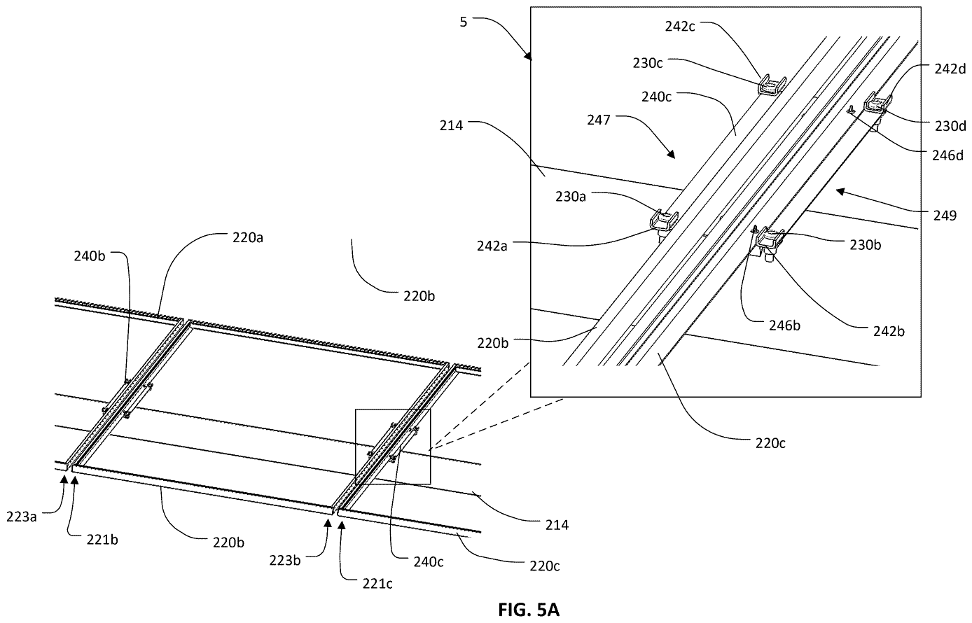

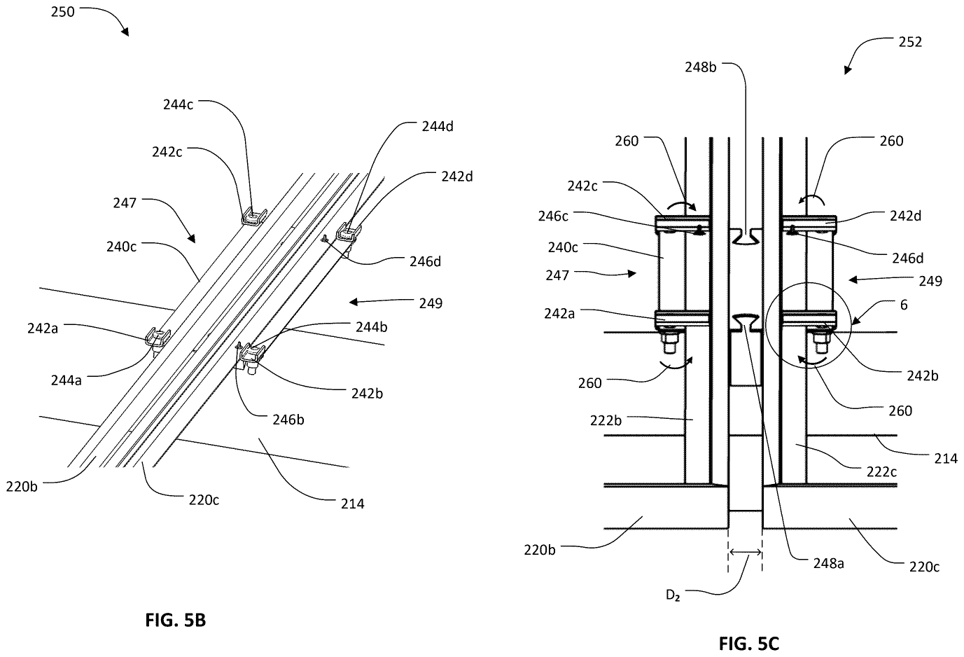

FIG. 5A is a schematic, perspective view of a portion of the solar tracker 200 including the plurality of solar modules 212 and the plurality of rails 240 with solar module glass and solar cells removed so the plurality of rails 240 are visible therethrough. FIG. 5B is a schematic, perspective view of a portion of the second solar module frame 220b and the third solar module frame 220c coupled to the third rail 240c and the torque tube 214 with the plurality of clamps 242 in the first, open position 250, and FIG. 5C a schematic, top-perspective view of the portion of the second solar module frame 220b and the third solar module frame 220c coupled to the third rail 240c and the torque tube 214 with the plurality of clamps 242 in the second, closed position 252.

As shown in Block 5 in FIG. 5A, the second solar module frame 220b and the third solar module frame 220c may be placed on the third rail 240c and aligned such that each of the plurality of locating tabs 246 protrude into the respective holes of the plurality of holes 226 in the second solar module frame 220b and the third solar module frame 220c. Such locating tabs 246 can be configured to align the solar modules 212 in the longitudinal and transverse directions with respect to the torque tube 214. Once aligned, a human or robotic installer may grasp and rotate each of the plurality of clamps 242 90-degrees, as indicated by arrows 260 in FIG. 5C. Alternatively, a human or a robotic installer may use a fastener tool (not shown) to engage the plurality of fastening mechanisms 230 and rotate each of the plurality of fastening mechanisms 230 approximately 90-degrees, which concurrently rotates the plurality of clamps 242 approximately 90-degrees, as indicated by arrows 260 in FIG. 5C. Such rotation can cause the plurality of clamps 242 to move from the first, open position 250 to the second, closed position 252, and for instance, engage a coupling flange 222b, 222c at the respective solar module frames 220b, 220c to secure the solar module frames 220b, 220c to the third rail 240c and thus to the torque tube 214. A user may then use the fastener tool to complete the tightening of the plurality of fastening mechanisms 230, which may further apply a desired clamp load on the plurality of clamps 242, and thereby on the coupling flange 222b, 222c of the solar module frame 220.

FIG. 5C further illustrates the placement of the second solar module frame 220b and the third solar module frame 220c on the third rail 240c. As shown, the second solar module frame 220b and the third solar module frame 220c are positioned such that there is a distance D₂ therebetween. The distance D₂ between the second solar module frame 220b and the third solar module frame 220c allows for the first end 217b, 217c or the second end 219b, 219b of the solar modules 212b, 212c, respectively to extend away from and/or compress toward one another. The extending away from and/or compressing toward one another may increase load that may be transferred to the third rail 240c and/or the plurality of rotatable clamps 242. This additional load may be alleviated by the first opening 248a and the second opening 248b, as discussed elsewhere herein. While the second solar module frame 220b and the third solar module frame 220c are described with respect to FIGS. 5A to 5C, it will be appreciated that the description of the second solar module frame 220b and the third solar module frame 220c further applies to each of the plurality of solar module frames 220.

FIG. 6 is an enlarged view of the second rotatable clamp 242b of the plurality of rotatable clamps 242, shown in Circle 6 in FIG. 5C. As shown in FIG. 6, the second rotatable clamp 242b is in the second, closed position 252, in which the second rotatable clamp 242b has been rotated and positioned over the coupling flange 222c of the solar module frame 220c. The rotation of the second rotatable clamp 242b may include rotating the second rotatable clamp 242b 90-degrees from the first, open position 250 to the second, closed position 252. The coupling flange 222c of the solar module frame 220c may be positioned at a bottom-side (e.g., bottom-side 223 shown in FIGS. 8A to 8B) of the solar module frame 220c and may extend outward from the solar module frame 220c in a direction similar to or the same as the third solar module 212c, although this is not explicitly shown in FIG. 6.

The second rotatable clamp 242b and the third rail 240c may define a frame distance D₁ therebetween when the second rotatable clamp 242b is in the second, closed position 252, as indicated in FIG. 6. Further, as shown in FIG. 6, the coupling flange 222c of the solar module frame 220c may be a flat sheet configuration that includes the thickness T₁. In some examples, the thickness T₁ may be about 1 mm (millimeter). In other examples, the thickness T₁ may be less than or greater than 1 mm. In some examples, the frame distance D₁ may define a frame distance width, wherein the frame distance width generally equal to the thickness T₁ of the coupling flange 222c of the solar module frame 220c.

As shown in FIG. 6, the third rail 240c may include a backing tab 234b. The backing tab 234b may correspond with the second rotatable clamp 242b. The backing tab 234b may further support the second rotatable clamp 242b and aid in the second rotatable clamp 242b exerting a consistent, downward force on the coupling flange 222c. For example, the backing tab 234b may include a height configured to be the same as or similar to the thickness T₁ of the coupling flange 222c of the solar module frame 220c. As such, the backing tab 234b prevents the second rotatable clamp 242b from closing the distance D₁ between the second rotatable clamp 242b and the third rail 240c, thereby keeping the second rotatable clamp 242b in plane (e.g., level) to maintain surface contact between the tab portion 244b and the coupling flange 222c. Further, when the second rotatable clamp 242b has been rotated from the first, open position 250 to the second, closed position 252, an end portion 236b of the second rotatable clamp 242b engages the backing tab 234b, helping prevent the second rotatable clamp 242b from rotating beyond the 90-degrees of desired rotation. The backing tab 234b may further prevent movement of the solar module frame 220c. While the backing tab 234b, the second rotatable clamp 242b, and the third rail 240c have been described with reference to FIG. 6, it will be appreciated that the description of the backing tab 234b further applies to a plurality of backing tabs 234 (234a, 234c, 234d), the description of the second rotatable clamp 242b further applies to each of the plurality of rotatable clamps 242, and the description of the third rail 240c further applies to each rail 240.

FIG. 7 is a bottom view of the third solar module 212c including the solar module frame 220c that can be used with the plurality of rotatable clamps 242. The solar module frame 220c may include the coupling flange 222c including a plurality of holes 226. The plurality of holes 226 may be configured to align with the plurality of locating tabs 246 of the rail 240. As discussed elsewhere herein, when the solar module frame 220c is placed on the rail 240, an installer may know it is centered when each of the plurality of locating tabs 246 protrude into the plurality of holes 226 positioned in the coupling flange 222c in the solar module frame 220c, thereby potentially eliminating the need for alignment in the direction transverse to the torque tube 214. While the third solar module 212c and the solar module frame 220c is discussed with reference to FIG. 8, it will be appreciated that the description of the third solar module 212c and the solar module frame 220c further applies to the solar modules 212a, 212b and the solar module frames 220a, 220b. Thus, each of the solar module frames 220a, 220b further includes a coupling flange, although not explicitly shown.

FIG. 8A is a side, cross-sectional view of the third solar module 212c including the solar module frame 220c that can be used with the plurality of rotatable clamps 242, and FIG. 8B is a side, cross-sectional view of the solar module frame 220c that can be used with the plurality of rotatable clamps 242 shown without the third solar module 212c. The solar module frame 220c may include a side portion 224c. The side portion 224c may be a longitudinal perimeter portion of the solar module frame 220c (e.g., which is longer than two radial perimeter portions that extend normal to the longitudinal perimeter portion of the solar module frame 220c). The solar module frame 220c may further include a photovoltaic laminate receptacle 225c and the coupling flange 222c opposite the receptacle 225c. Thus, the side portion 224c may be positioned between the receptacle 225c and the coupling flange 222

The coupling flange 222c of the solar module frame 220c may be positioned at a bottom-side 223 of the solar module frame 220c and may extend inward from the solar module frame 220c in a direction similar to or the same as the third solar module 212c. The coupling flange 222c may be a flattened flange that includes the thickness T₁. The coupling flange 222c may include the plurality of holes 226, as shown in FIG. 8A. The plurality of holes 226 may be configured to align with the plurality of locating tabs 246 of the rail 240.

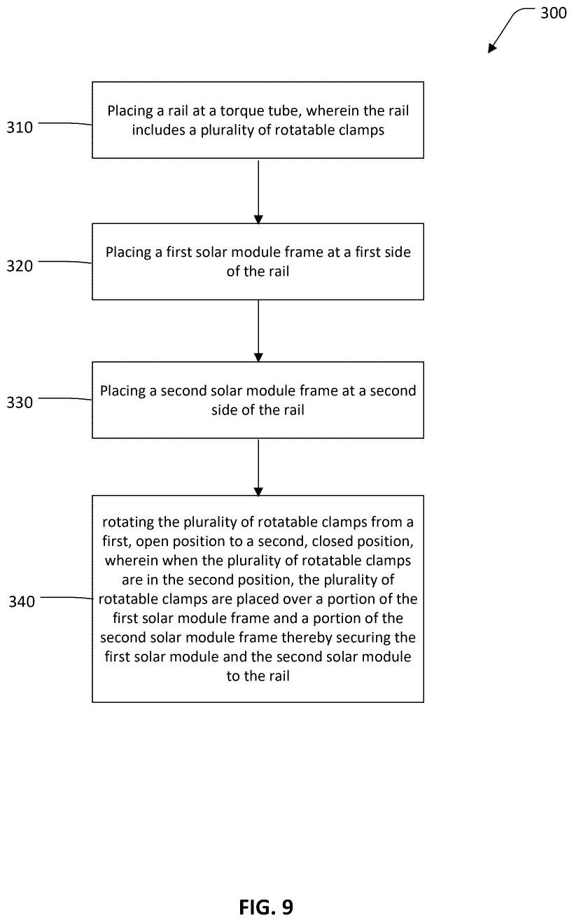

FIG. 9 is a flow diagram illustrating a method 300 for coupling a first solar module frame and a second solar module frame to a torque tube (e.g., torque tube 214). The method 300 may be suitable for coupling any of the solar module frames 220 described herein to the torque tube 214. The method 300 may include placing a rail (e.g., rail 240) at the torque tube (e.g., torque tube 214), wherein the rail may include a plurality of rotatable clamps (e.g., plurality of rotatable clamps 242), as referenced by block 310. The first solar module frame (e.g. solar module frame 220a) may be placed at a first side of the rail (e.g., first side 247), as referenced by block 320, and the second solar module frame (e.g., solar module frame 220b) may be placed at a second side of the rail (e.g., second side 249), as referenced by block 330. Placing the first solar module frame and the second solar module frame at the rail may include alignment of each hole of the plurality of holes (e.g., plurality of holes 226) with a corresponding locating tab of the plurality of locating tabs (e.g., plurality of locating tabs 246) of the rail. The method 300 may further include rotating the plurality of rotatable clamps from a first, open position to a second, closed position. When the plurality of rotatable clamps are in the second position, the plurality of rotatable clamps are placed over a portion of the first solar module frame and a portion of the second solar module frame thereby securing the first solar module and the second solar module to the rail, as referenced by block 340.

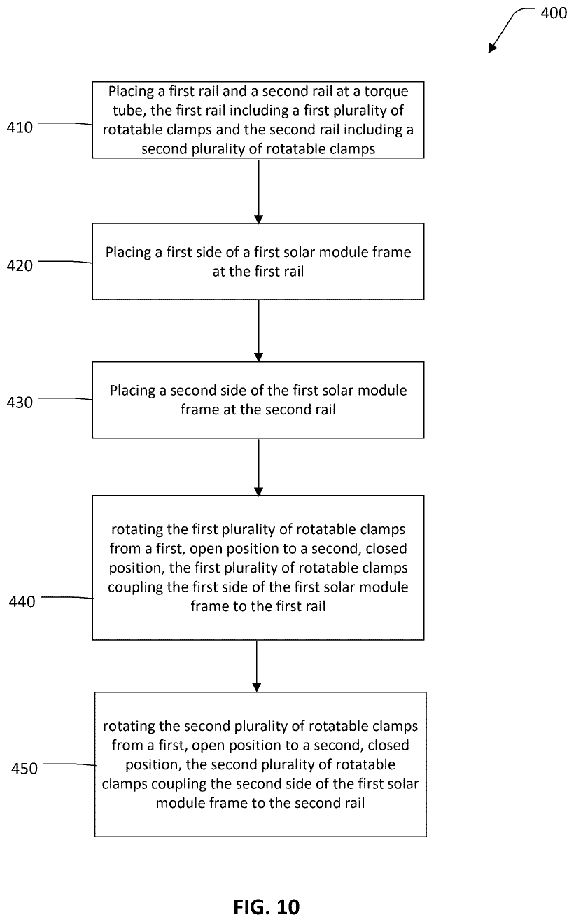

FIG. 10 is a flow diagram illustrating a method 400 for coupling a first solar module frame (e.g., second solar module frame 220b shown in FIG. 5A) to a torque tube (e.g., torque tube 214). The method 400 may be suitable for coupling any of the solar module frames 220 described herein to the torque tube 214. The method may include placing a first rail (e.g., rail 240b shown in FIG. 5A) and a second rail (e.g., rail 240c shown in FIG. 5A) at the torque tube. The first rail may include a first plurality of rotatable clamps, and the second rail may include a second plurality of rotatable clamps, as referenced by block 410. A first side (e.g., first side 221b shown in FIG. 5A) of the first solar module frame may be placed at the first rail, as referenced by block 420, and a second side (e.g., second side 223b as shown in FIG. 5A) may be placed at the second rail, as referenced by block 430. Placing the first solar module frame at the first rail and the second rail may include alignment of each hole of the plurality of holes (e.g., plurality of holes 226) with a corresponding locating tab of the plurality of locating tabs (e.g., plurality of locating tabs 246) of the rails, as described elsewhere herein. The method 400 may further include rotating the first plurality of rotatable clamps from a first, open position to a second, closed position, the first plurality of rotatable clamps coupling the first side of the first solar module frame to the first rail, as referenced by block 440, and rotating the second plurality of rotatable clamps from a first, open position to a second, closed position, the second plurality of rotatable clamps coupling the second side of the first solar module frame to the second rail, as referenced by block 450. The first plurality of rotatable clamps may contact a first coupling flange (e.g., coupling flange 222b) located on the first side of the first solar module frame, and the second plurality of rotatable clamps may contact a second coupling flange (e.g., coupling flange 222b, as coupling flange 222b extends around an internal perimeter of the second solar module frame 220b) located on the second side of the first solar module frame. Further, the first plurality of rotatable clamps may be secured to the first rail via a plurality of first fasteners when the first plurality of rotatable clamps are in the closed position, and the second plurality of rotatable clamps may be secured to the second rail via a plurality of second fasteners when the second plurality of rotatable clamps are in the closed position.

The example solar module frames (220a, 220b, 220c) described herein may be formed from a sheet metal, such as a steel sheet. In some examples, the solar module frames (220a, 220b, 220c) may be formed from aluminum, such as by extruding aluminum. In some examples, the solar module frames (220a, 220b, 220c) may be formed from titanium, stainless steel, nickel alloys, platinum, or the like. The solar module frames (220a, 220b, 220c) may be formed by bending with bends or folds to form the desired profile. The solar module frames (220a, 220b, 220c) described herein may be configured to couple to the torque tube (214) via the plurality of rotatable clamps (242a, 242b, 242c, 242d) of the rails (240a, 240b, 240c, 240d) described herein.

Various non-limiting exemplary embodiments have been described. It will be appreciated that suitable alternatives are possible without departing from the scope of the examples described herein.

1. A method for coupling a first solar module frame and a second solar module frame to a torque tube, the method comprising the steps of:
placing a rail at the torque tube, the rail having a plurality of rotatable clamps;
placing the first solar module frame at a first side of the rail;
placing the second solar module frame at a second side of the rail; and
rotating the plurality of rotatable clamps from a first, open position to a second, closed position;
wherein when the plurality of rotatable clamps are in the second position, the plurality of rotatable clamps are placed over a portion of the first solar module frame and a portion of the second solar module frame, thereby securing the first solar module frame and the second solar module frame to the rail.

2. The method of claim 1, wherein each of the plurality of rotatable clamps is secured to the rail via a threaded fastener, the threaded fastener comprising one of a bobtail fastener, a screw, or a bolt.

3. The method of claim 2, wherein each of threaded fasteners for each of the plurality of rotatable clamps is preinstalled into the rail prior to placing the rail at the torque tube.

4. The method of claim 2, further comprising tightening each of the threaded fasteners to cause the plurality of rotatable clamps to engage the first solar module frame or the second solar module frame when the plurality of rotatable clamps are placed over the first solar module frame and the second solar module frame respectively, the tightening of the threaded fasteners securing the first solar module frame and the second solar module frame to the rail.

5. The method of claim 1, wherein the plurality of rotatable clamps and the rail define a frame distance therebetween when the plurality of rotatable clamps are in the second, closed position.

6. The method of claim 5, wherein the frame distance defines a frame distance width, and wherein the frame distance width is greater than a thickness of the first solar module frame and the second solar module frame.

7. The method of claim 1, wherein the rail includes a plurality of locating tabs;
wherein the first solar module frame and the second solar module frame each include a plurality of holes; and
wherein placing the first solar module frame and the second solar module frame at the rail includes alignment of each hole of the plurality of holes with a corresponding locating tab of the plurality of locating tabs of the rail.

8. The method of claim 1, wherein the rotating of the plurality of rotatable clamps includes rotating the plurality of rotatable clamps approximately 90-degrees from the first, open position to the second, closed position.

9. The method of claim 1, wherein the rail defines a first opening at a first end of the rail and a second opening at a second end of the rail.

10. A rail for coupling a solar module to a torque tube, the rail comprising:
a rail base having a first end, a second end opposite the first end, a first side, and a second side opposite the second side, the rail base configured to couple to the torque tube;
a plurality of locating tabs positioned on the rail base; and
a plurality of rotatable clamps, the plurality of rotatable clamps rotatable from a first, open position to a second, closed position, the plurality of rotatable clamps configured to engage a flanged region of the solar module and secure the solar module to the rail.

11. The rail of claim 10, wherein the rail further defines a first opening at the first end of the rail base and defines a second opening at the second end of the rail base.

12. The rail of claim 11, wherein the first opening and the second opening enable relative movement between the first side and the second side of the rail base.

13. The rail of claim 12, wherein the first opening enables the first side to move laterally closer to, or laterally further away from, the second side than a width of rail base.

14. The rail of claim 10, wherein the plurality of rotatable clamps are configured to be pre-installed on the rail base.

15. The rail of claim 10, wherein the rail further comprises a plurality of backing tabs, each of the plurality of backing tabs corresponding with one of the plurality of rotatable clamps, each of the plurality of backing tabs configured to support the corresponding rotatable clamp when the rotatable clamp is in the closed position to aid in exerting a downward force on a coupling flange of the solar module.

16. The rail of claim 15, wherein each of the plurality of backing tabs has a height approximately the same as a thickness of the coupling flange of the solar module.

17. The rail of claim 10, wherein each of the plurality of locating tabs is configured to align with a corresponding one of a plurality of holes on a coupling flange of the solar module, the plurality of locating tabs configured to protrude through the plurality of holes of the solar module when the solar module is aligned with the rail.

18. A method for coupling a first solar module frame to a torque tube, the method comprising:
placing a first rail and a second rail at the torque tube, the first rail including a first plurality of rotatable clamps and the second rail including a second plurality of rotatable clamps;
placing a first side of the first solar module frame at the first rail;
placing a second side of the first solar module frame at the second rail;
rotating the first plurality of rotatable clamps from a first, open position to a second, closed position, the first plurality of rotatable clamps coupling the first side of the first solar module frame to the first rail; and
rotating the second plurality of rotatable clamps from a first, open position to a second, closed position, the second plurality of rotatable clamps coupling the second side of the first solar module frame to the second rail.

19. The method of claim 18, wherein the first plurality of rotatable clamps contact a first coupling flange located on the first side of the first solar module frame, and the second plurality of rotatable clamps contact a second coupling flange located on the second side of the first solar module frame.

20. The method of claim 18, wherein the first plurality of rotatable clamps are coupled to the first rail via a corresponding plurality of first fasteners, the plurality of first fasteners being preinstalled to the first rail;
wherein the second plurality of rotatable clamps are coupled to the second rail via a corresponding plurality of second fasteners, the plurality of second fasteners being preinstalled to the second rail; and
wherein the method further comprises:
securing the first plurality of rotatable clamps to the first rail via the plurality of first fasteners when the first plurality of rotatable clamps are in the closed position; and
securing the second plurality of rotatable clamps to the second rail via the plurality of second fasteners when the second plurality of rotatable clamps are in the closed position.
